(19) United States
(12) Patent Application Publication
(10) Pub. No.: US 2024/0375658 A1
(43) Pub. Date: Nov. 14, 2024

(54) METHOD FOR MANAGING THE LONGITUDINAL SPEED OF AN AUTONOMOUS VEHICLE

(71) Applicant: RENAULT S.A.S., Boulogne Billancourt (FR)

(72) Inventors: Marouane BENAZIZ, Cesson-Sevigne (FR); Pedro KVIESKA, Guyancourt cedex (FR); Sébastien SALIOU, Rennes (FR); Antoine SIMONIN, Guyancourt cedex (FR)

(73) Assignee: RENAULT S.A.S., Boulogne Billancourt (FR)

(21) Appl. No.: 18/559,676

(22) PCT Filed: May 11, 2022
(86) PCT No.: PCT/EP2022/062814

§ 371 Date: Nov. 8, 2023

(30) Foreign Application Priority Data
May 11, 2021 (FR) 2104998

(51) Int. Cl. B60W 30/18; B60W 60/00

(52) U.S. Cl. CPC B60W 30/18154; B60W 30/18072; B60W 60/0013; B60W 2554/20; B60W 2554/802; B60W 2555/60

(57) ABSTRACT

A method for managing longitudinal speed of an autonomous vehicle travelling on a traffic lane including stop signage located in front of the autonomous vehicle. The autonomous vehicle is equipped with a first detector to detect a first range and a second detector to detect a second range. The first range is greater than the second range. The method includes detecting the stop signage by the first detector and implementing a first deceleration logic and detecting the stop signage by the second detector and implementing a second deceleration logic. The first and second deceleration logic implement jerks, the absolute value of which is less than a first threshold. The second deceleration logic controls the stopping of the autonomous vehicle with an accuracy of around one centimeter relative to the stop signage.

The invention relates to a method for managing the longitudinal speed of an autonomous vehicle. The invention also relates to a device for managing the longitudinal speed of an autonomous vehicle. The invention also relates to a computer program implementing the aforementioned method. The invention lastly relates to a storage medium on which such a program is stored.

Automated speed-managing systems are commonly installed in present-day vehicles, and are being upgraded to incorporate new functionalities.

One upgrade regards automated management of stoppage of the autonomous vehicle at a road sign, a stop sign for example, or at a traffic light.

This feature requires the stopping point of the vehicle to be accurately located. To this end, use of a front-view camera with which the vehicle is equipped allows the stopping point to be located accurately, and therefore the slowdown and stoppage of the autonomous vehicle at the road sign or traffic light to be managed automatically. However, this solution has the drawback of being limited by the range of a camera, which is less than 50 meters. In other words, this solution allows a stopping point of the vehicle to be accurately located, but only when it is located less than 50 meters from the vehicle. Such a delay before detection of the need to soon stop the vehicle means that braking cannot be guaranteed to meet conditions ensuring autonomous-vehicle driving comfort.

The aim of the invention is to provide a device and method for managing the longitudinal speed of an autonomous vehicle that remedy the above drawbacks and improve on the devices and methods for managing longitudinal speed that are known in the prior art. In particular, the invention makes it possible to provide a device and method that are simple and reliable and that make it possible, on the one hand, to accurately locate an upcoming stopping point of an autonomous vehicle, and on the other hand, to control stoppage of the autonomous vehicle at this upcoming stopping point, while guaranteeing braking comfort.

To this end, the invention relates to a method for managing the longitudinal speed of an autonomous vehicle, the autonomous vehicle traveling on a roadway comprising a stop sign located in front of the autonomous vehicle, the autonomous vehicle being equipped with a first detecting means of a first range and with a second detecting means of a second range, the first range being greater than the second range.

The method comprises:
a first step of detecting the stop sign with the first detecting means, and of implementing first slowdown logic to slow down the autonomous vehicle,
a second step of detecting the stop sign with the second detecting means, and of implementing second slowdown logic to slow down the autonomous vehicle.

In addition, the first and second slowdown logic implement jerks the absolute value of which is less than a first limit threshold, and the second slowdown logic controls stoppage of the autonomous vehicle with an accuracy of the order of one centimeter relative to the stop sign, or of the order of ten centimeters relative to the stop sign, or of the order of several tens of centimeters relative to the stop sign.

The first and second slowdown logic may implement negative accelerations greater than a second threshold limit.

The first step may comprise determining, at a first time, an approximate first position of the stop sign, and the second determining step may comprise determining, at a second time, an accurate second position of the stop sign, the second time being strictly after the first time.

The first slowdown logic may initiate a first decelerating phase when the vehicle reaches a given distance from the approximate first position of the stop sign.

The second slowdown logic may start a second decelerating phase at the second time, and the second decelerating phase may exhibit continuity in speed and acceleration with the first decelerating phase.

The absolute value of the jerk at the end of the first decelerating phase may be greater than the absolute value of the jerk at the start of the first decelerating phase, and/or the absolute value of the jerk at the end of the second decelerating phase may be greater than the absolute value of the jerk at the start of the second decelerating phase.

The first decelerating phase may be composed of three consecutive sub-phases, a first initial sub-phase having a first non-zero constant jerk, a first intermediate sub-phase having a jerk of zero, and a first final sub-phase having a second non-zero constant jerk. Alternatively or in addition, the second decelerating phase may be composed of three consecutive sub-phases, a second initial sub-phase having a third non-zero constant jerk, a second intermediate sub-phase having a jerk of zero, and a second final sub-phase having a fourth non-zero constant jerk.

The second jerk may be the product of the first jerk multiplied by a first multiplicative factor, in particular a first multiplicative factor the sign of which is the sign of the product between, on the one hand, the difference between a first acceleration of the end of the first final sub-phase and a second acceleration of the first intermediate sub-phase, and, on the other hand, the difference between the second acceleration and a third acceleration of the start of the first initial sub-phase. Alternatively or in addition, the fourth jerk may be the product of the third jerk multiplied by a second multiplicative factor, in particular a second multiplicative factor the sign of which is the sign of the product between, on the one hand, the difference between a fourth acceleration of the end of the second final sub-phase and a fifth acceleration of the second intermediate sub-phase, and, on the other hand, the difference between the fifth acceleration and a sixth acceleration of the start of the second initial sub-phase.

The invention further relates to a device for managing the longitudinal speed of an autonomous vehicle, the autonomous vehicle being equipped with a brake actuator. The device comprises hardware and/or software elements implementing the method such as defined above, in particular hardware and/or software elements designed to implement the method according to the invention, and/or the device comprising means for implementing the method such as defined above.

The invention further relates to an autonomous longitudinal vehicle the speed of which is managed according to the invention.

The invention also relates to a computer program product comprising program code instructions stored on a computer-readable medium for implementing the steps of the method such as defined above when said program is run on a computer. The invention also relates to a computer program product that is downloadable from a communication network and/or stored on a computer-readable and/or computer-executable data medium, comprising instructions that, when the program is executed by the computer, cause the latter to implement the method such as defined above.

The invention also relates to a computer-readable data storage medium on which is stored a computer program comprising program code instructions for implementing the method such as defined above. The invention also relates to a computer-readable storage medium comprising instructions that, when they are executed by a computer, cause the latter to implement the method such as defined above.

The invention also relates to a signal of a data medium carrying the computer program product defined above.

The appended drawings show, by way of example, one embodiment of a managing device according to the invention and one mode of execution of a managing method according to the invention.

FIG. 1 shows one embodiment of an autonomous vehicle implementing a method for managing the longitudinal speed of an autonomous vehicle.

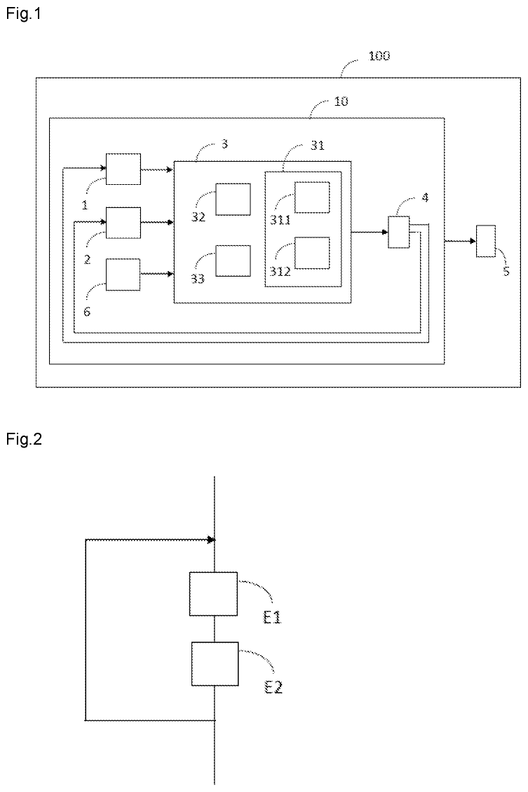

FIG. 2 is a flowchart of one mode of execution of a method for managing the longitudinal speed of an autonomous vehicle.

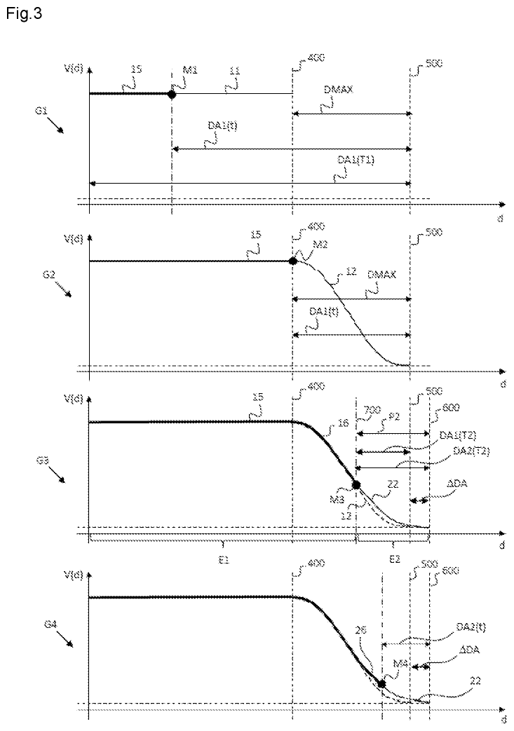

FIG. 3 shows the variation in the speed of the autonomous vehicle as a function of the distance it has traveled since a time of detection of an upcoming stop.

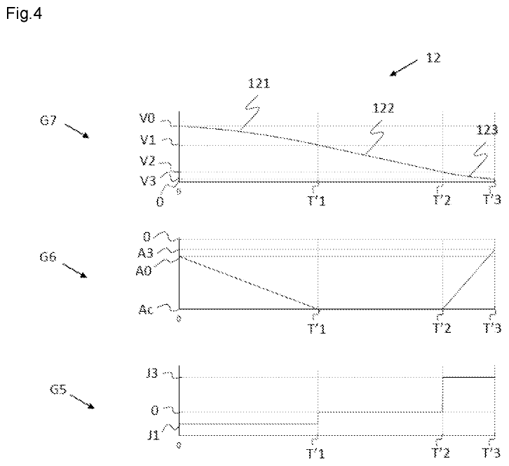

FIG. 4 shows a speed profile implemented to brake the autonomous vehicle according to the first slowdown logic.

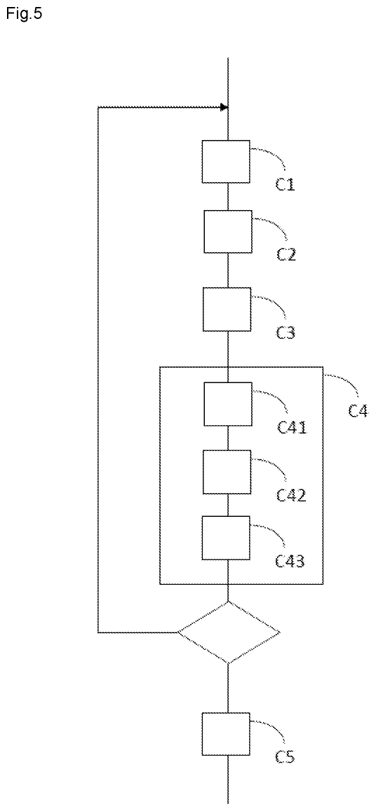

FIG. 5 is a flowchart of a method for calibrating a speed profile implemented to brake the autonomous vehicle according to the first or second slowdown logic.

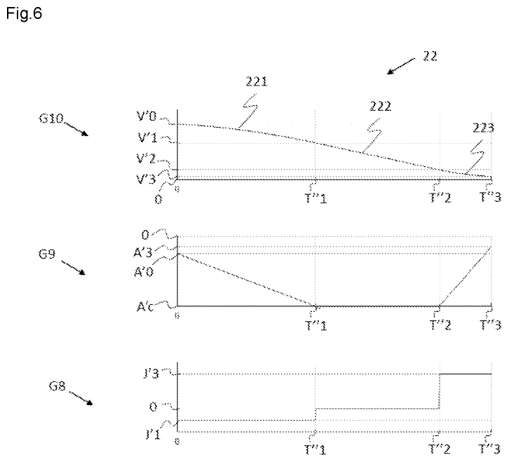

FIG. 6 shows a speed profile implemented to brake the autonomous vehicle according to the second slowdown logic.

The autonomous vehicle 100 may be an autonomous vehicle of any type, such as a passenger vehicle, a commercial vehicle, a truck or a public transport vehicle such as a bus or shuttle.

It is assumed that the autonomous vehicle 100 is traveling a route with an upcoming stop ARR located in front of the autonomous vehicle. In the rest of the document, the term “upcoming stop” is used to designate the sign (for example a stop sign) or a traffic light that may require the vehicle to stop. If there are a plurality of signs or lights on the route, the upcoming stop is the one that the autonomous vehicle will reach first. The term “stop position” designates the position of the upcoming stop. The stop position is determined by a perceiving means; the accuracy of the stop position therefore depends on the accuracy of the perceiving means.

The autonomous vehicle 100 comprises a managing system 10 and a brake actuator 5 and/or a control unit of a motor providing the vehicle with drive. The brake actuator 5 and/or the control unit providing the vehicle with drive receive commands from the managing system 10 in order to implement a slowdown of the autonomous vehicle according to slowdown logic determined by the managing system 10.

The term “slowdown logic” is used in the rest of the document to designate a mode of determining a longitudinal speed profile, longitudinal acceleration profile and longitudinal jerk profile allowing the autonomous vehicle to be stopped at an upcoming stop, the position of the upcoming stop being determined by a detecting means. In the rest of the document, the term “jerk” designates the derivative of acceleration with respect to time. In particular, the term “longitudinal jerk” designates the derivative of longitudinal acceleration with respect to time.

The managing system 10 mainly comprises the following components:
a first detecting means 1,
a second detecting means 2,
a path-planning system 4,
a set of speed, acceleration and jerk sensors 6,
and a computing unit 3 comprising a microprocessor 31, an electronic memory 32 and communication interfaces 33 allowing the microprocessor 31 to communicate with the detecting means 1, 2, the path-planning system 4 and the set of sensors 6.

The path-planning system 4 determines a path between a start point and an end point of the autonomous vehicle 100. In the rest of the document, the term “path” is used to designate the variation as a function of time in a state vector defining the characteristics of the movement of the autonomous vehicle 100. In one preferred embodiment, the state vector comprises a position, in particular x, y coordinates, longitudinal and lateral speeds and/or longitudinal and lateral accelerations and/or a yaw rate and/or a jerk. In the rest of the document, the term “position” is used to designate either to the x, y coordinates of the state vector, or the state vector in its entirety.

The first detecting means 1 comprises a detecting means of a first range P1. The first detection range P1 is a long range, for example it is of the order of several hundred meters, or even of the order of one thousand meters.

In one embodiment, the first detecting means 1 comprises a GPS location of the autonomous vehicle 100 on a standard definition map, referred to as the SD map in the rest of the document. The accuracy of the first detecting means 1 is therefore determined by the accuracy of the GPS location, which is of the order of a few meters.

The first detecting means 1 is able to receive data from the path-planning system 4. The path-planning data make it possible to detect, within the limit of the range P1, and at a first given time T1, the upcoming stop ARR located on the planned path of the autonomous vehicle 100.

The first detecting means 1 further comprises means for computing a first stopping distance DA1 separating the autonomous vehicle 100 from a first stop position PA1 associated with the upcoming stop ARR. The distance DA1 is a curvilinear distance corresponding to the length of the path segment bounded by the current position of the autonomous vehicle 100 and by the stop position PA1. The accuracy of the distance DA1 is of the order of a few meters—for example it is comprised between 3 and 5 meters or between 1 and 10 meters.

It will be noted that the first detecting means 1 does not use a high-definition map.

The second detecting means 2 comprises a detecting means of a second range P2. The second detection range P2 is a limited range, in particular it is less or markedly less than the first detection range P1 of the first detecting means 1. For example, the range P2 is of the order of a few tens of meters. In contrast, the second detecting means 2 allows objects of the road scene to be located with a level of accuracy markedly greater than that of the first detecting means 1.

In one embodiment, the second detecting means 2 comprises a camera, in particular a front-view camera, allowing the autonomous vehicle 100 to be located relative to elements of the road scene with an accuracy of the order of one centimeter, or of about ten centimeters or of a few tens of centimeters. In this embodiment, the range P2 of the second detecting means is of the order of about forty or of about fifty meters, under ideal weather and luminosity conditions. The range P2 may also be limited by road infrastructure—for example when the road makes a sharp turn—or by road traffic, for example when the autonomous vehicle 100 is behind a truck.

The second detecting means 2 is able to receive data from the path-planning system 4. The path-planning data, compared with the images of the camera, make it possible to detect the upcoming stop ARR within the limit of the range P2 and at a second given time T2.

The second detecting means 2 further comprises means for computing a second stopping distance DA2 separating the autonomous vehicle 100 from a stop position PA2 associated with the upcoming stop ARR. The distance DA2 is a curvilinear distance corresponding to the length of the path segment bounded by the current position of the autonomous vehicle 100 and by the stop position PA2. The accuracy of the distance DA2 is of the order of about ten centimeters—for example it is less than 20 centimeters, or even less than 15 centimeters or than 10 centimeters, or indeed it may be of the order of one centimeter.

It will be noted that the second detecting means does not use a high-definition map.

The set of sensors 6 delivers the speed, acceleration and jerk of the autonomous vehicle 100 at all times.

In one embodiment, the microprocessor 31 is able to execute software comprising the following modules, which cooperate with one another:
a module 311 for detecting a stop sign with the first detecting means, and for implementing first slowdown logic to slow down the autonomous vehicle, which cooperates with the first detecting system 1, the path-planning system 4, and the set of sensors 6, and
a module 312 for detecting a stop sign with the second detecting means, and for implementing second slowdown logic to slow down the autonomous vehicle, which cooperates with the second detecting system 2, the path-planning system 4, and the set of sensors 6.

The autonomous vehicle 100, in particular the system 10 for automatically managing longitudinal speed, preferably comprises all the required hardware and/or software elements configured so as to implement the method defined in the subject matter of the invention or the method described below.

One mode of execution of the managing method is described below with reference to FIG. 2. The method comprises two steps E1 and E2 which are executed in succession.

In the first step E1, a stop signal is detected by virtue of the first detecting means 1, then first slowdown logic is implemented to slow down the autonomous vehicle 100.

At a first time T1, the first detecting means 1 receives information on the position POS1 of the autonomous vehicle 100 from the GPS. The position POS1 allows the autonomous vehicle 100 to be located on the SD map. Having combined the path-planning, vehicle-position and SD-map information, the presence of a stop sign is sought on the route segment located in front of the autonomous vehicle 100 and within the range of the first detecting means 1. The stop sign closest to the autonomous vehicle 100 will be detected as being an upcoming stop ARR of the autonomous vehicle 100. The first detecting means 1 thus determines a first position PA1 of the upcoming stop ARR.

Thus, the first step E1 comprises determining, at a first time T1, an approximate first position of the stop sign, i.e. determining the first stop position PA1.

First slowdown logic is then implemented.

For this purpose, at each time t of receipt of a GPS position, the stopping distance DA1(t), which is the curvilinear distance separating the autonomous vehicle 100 from the position PA1 at the time t, is computed.

In one preferred embodiment, the first slowdown logic comprises a comparison of the stopping distance DA1(t) with a maximum distance threshold DMAX in order to determine whether the autonomous vehicle is, at the time t, sufficiently close to the stop position PA1 to begin to slow down.

The threshold DMAX may have a constant value, 300 meters for example. Alternatively, the threshold DMAX may be a variable depending, for example, on the current speed of the autonomous vehicle, which is measured by the set of sensors 6.

The distance threshold DMAX makes it possible to break down the first slowdown logic into two phases,
a braking anticipation phase, starting at the time T1 of first detection of the upcoming stop ARR, and during which the distance DA1(t) between the autonomous vehicle 100 and the upcoming stop ARR is strictly greater than DMAX, and
a braking phase during which the distance DA1(t) between the autonomous vehicle 100 and the upcoming stop ARR is less than or equal to DMAX.

Various embodiments of the braking anticipation phase may be envisioned.

Firstly, during the anticipation phase, the autonomous vehicle 100 could keep to the path initially planned by the path-planning system 4. In other words, the autonomous vehicle 100 could continue its journey toward the upcoming stop ARR according to the speed, acceleration and jerk curves initially determined by the path-planning system 4, until the autonomous vehicle reaches a distance DMAX from the upcoming stop.

In one alternative embodiment, during the anticipation phase, the acceleration of the autonomous vehicle ARR could be limited to a maximum threshold. For example, acceleration could be reduced to a range of values, called valid values, less than or equal to 0 m/s². In this case, the range of valid values would be transmitted to the path-planning system 4 with a view to computation of a new path using accelerations within the range of valid values.

Other embodiments of the anticipation phase may be envisaged—for example a deceleration ramp simulating a release of the accelerator pedal by a human driver may be employed, the autonomous vehicle 100 slowing down simply because of braking via engine/motor braking.

Whatever the embodiment of the anticipation phase, the distance DA1(t) gradually decreases until it becomes less than or equal to the threshold DMAX. The autonomous vehicle 100 then enters the braking and/or decelerating phase of the first slowdown logic.

In the rest of the document, the braking and/or decelerating phase is referred to as the “braking phase”.

FIG. 3 comprises four graphs, G1, G2, G3, G4, showing the variation in the speed of the autonomous vehicle 100 as a function of the distance d (t) which it has traveled since the time T1 of detection of an upcoming stop ARR.

The graphs G1, G2, and G3 more specifically illustrate implementation of the first slowdown logic:
graph G1 illustrates performance of the anticipation phase,
graph G2 illustrates the transition between the anticipation phase and the braking phase of the first slowdown logic, and
graph G3 illustrates performance of the braking phase of the first slowdown logic and the transition between the first slowdown logic and the braking phase of the second slowdown logic.

For the sake of clarity, graphs G1 to G3 illustrate a situation in which the position PA1 of the upcoming stop ARR does not change during implementation of the first slowdown logic. However, it is possible for processing of the data received from the GPS to make the position PA1 of the upcoming stop change. In this case, the anticipation and braking phases are redefined according to the first slowdown logic.

In the graphs G1 to G3, the line 500 located at the abscissa DA1 represents a line of arrival of the vehicle at an upcoming stop ARR located at the position PA1 detected by the first detecting means 1. The line 400 located at the abscissa d3 represents the start of the braking phase of the first slowdown logic, the lines 400 and 500 being separated by DMAX.

The curves 11, 12 drawn with thin lines represent the speed profile planned for the autonomous vehicle 100, while the curves 15, 16 drawn with thick lines represent the speed profile implemented by the vehicle as it moves. Thus, points M0 to M3 shown in graphs G1 to G3 represent the points of change in the speed of the autonomous vehicle 100 along the curves 15, 16.

In the graph G1, the point M0 represents the speed of the autonomous vehicle 100 at the time T1 of detection of the upcoming stop ARR. The point M0 bounds the start of the braking anticipation phase. Since the point M1 is at a distance DA (t) from the upcoming stop that is strictly greater than DMAX, it is located in the braking anticipation phase.

In the illustrated example, the speed of the autonomous vehicle 100 is constant during the anticipation phase. As described above, the speed could however vary during the anticipation phase.

At a given time T12, the autonomous vehicle has reached a point M2 located at the distance DMAX from the position PA1 of the upcoming stop. The point M2, shown in the graph G2, represents the transition between the anticipation phase and the braking phase of the first slowdown logic. The point M2 is therefore the start point of a speed profile 12 implemented in the braking phase of the first slowdown logic.

A preferred embodiment of the speed profile 12 of the braking phase of the first slowdown logic is described below with reference to FIG. 4.

The speed profile 12 of the braking phase of the first slowdown logic preferably meets the following criteria:
the speed profile 12 allows the autonomous vehicle to reach the position PA1 with a substantially zero speed, and/or
the speed profiles 11 and 12 exhibit continuity in speed and acceleration at point M2, and/or
the speed profile 12 implements jerks the absolute value of which is less than a first limit threshold JMAX.

In a preferred embodiment described below with reference to FIG. 4 and corresponding to the most frequent situation where the autonomous vehicle is heading toward the stopping point without needing to accelerate, the speed profile 12 also meets the following criteria:
the speed profile 12 implements negative accelerations greater than a limit threshold AMIN, the threshold AMIN being able to be considered a maximum deceleration in absolute value, and/or
the speed profile 12 is composed of three consecutive sub-phases, an initial sub-phase 121 having a constant negative jerk J1, an intermediate sub-phase 122 having a jerk J2 of zero, and a final sub-phase 123 having a constant positive jerk J3, and/or
the positive jerk J3 of the final sub-phase 123 is greater than the absolute value of the negative jerk J1 of the initial sub-phase 121.

Advantageously, in the preferred embodiment, the speed profile 12 meets all of these criteria.

Other embodiments of the speed profile 12 may however be implemented in the managing method according to the invention.

For example, when the vehicle is driving on a slope such that its deceleration is great,
in the initial sub-phase 121, the acceleration may increase from a very negative first value A0 to a negative second value Ac greater than the first value A0,
then, it may be constant in the intermediate sub-phase 122,
then, it may increase again to a third value A3 in the final sub-phase 123. In this case, the jerk J1 will be positive and of the same sign as the jerk J3.

Likewise, in an alternative embodiment of the speed profile 12, a third negative acceleration value A3 could be implemented at the end of the final sub-phase 123, which acceleration value would be less than the first acceleration value A0 of the start of the initial sub-phase 121. In this case, the jerk J3 will be negative and of the same sign as the jerk J1.

As has already been noted, the position of the first stop position may change depending on data delivered by the first detecting means 1, and this will require the speed profile 12 to be recomputed to reflect a new position of the autonomous vehicle 100 relative to a new position of the upcoming stop.

The preferred embodiment of a speed profile 12 at a time t is therefore described below generically with reference to FIG. 4, between a given position M of the autonomous vehicle 100 at the time t, the point M possibly corresponding to the point M2, and a stop position PA known at the time t, the stop position possibly corresponding to the first stop position PA1. The curvilinear distance separating the positions M and PA at the time t is denoted DREF.

Graphs G5, G6 and G7 in FIG. 4 show the variation as a function of time in the jerk, acceleration and speed of the autonomous vehicle according to the speed profile 12, between point M (at the time T=0 s) and the stop position PA.

The speed profile 12 is defined by a set of parameters shown in graphs G5 to G7, including
parameters, referred to as fixed parameters, that are determined by path constraints at the point M and at the stop position PA, and
parameters, referred to as calibration parameters, the value of which may be modified so as to define a path between the point M and the position PA that respects comfort thresholds relating to jerk and acceleration.

The fixed parameters and the calibration parameters described below together make it possible to define the speed profile 12 in the three consecutive sub-phases 121, 122, 123 described above.

In the preferred embodiment, the initial sub-phase 121 takes place between the time T=0 s and a time T=T′1. During this sub-phase,
the jerk J1 is strictly negative and constant,
acceleration is a strictly decreasing linear function of time: it varies between two negative values A0 (at t=0 s) and Ac (at t=T′1),
speed is therefore a strictly decreasing function of the time varying between a value V0 (at T=0 s) and a value V1 (at T=T′1).

In the preferred embodiment, the intermediate sub-phase 122 takes place between the time T=T′1 and a time T=T′2. During this sub-phase,
the jerk J2 is zero,
acceleration therefore remains constant as a function of time: it is equal to the strictly negative value Ac between the times T′1 and T′2,
speed is therefore a strictly decreasing linear function of time varying between the value V1 (at t=T′1) and a value V2 (at t=T′2).

20) In the preferred embodiment, the final sub-phase 123 takes place between the time T=T′2 and a time T=T′3. During this sub-phase,
the jerk J3 is strictly positive and constant,
acceleration is therefore a strictly increasing linear function of time: it varies between the negative value Ac (at T=T′2) and a negative value A3 (at T=T′3),
speed is therefore a strictly decreasing function of time varying between the value V2 (at t=T′2) and a value V3 (at t=T′3).

The fixed parameters of the speed profile 12 comprise the speed V0 and acceleration A0 of the vehicle at time T=0 s. Since speed and acceleration are continuous at the point M, the speed V0 is equal to the speed of the autonomous vehicle 100 measured at the point M, and the acceleration A0 is equal to the acceleration of the autonomous vehicle 100 measured at the point M.

The fixed parameters of the speed profile also comprise the speed V3 and acceleration A3 of the vehicle at the position PA. Since the autonomous vehicle 100 must stop at the position PA, the parameters V3 and A3 are constants very close to 0. Their respective values may be set during configuration of the vehicle. The values V3 and A3 will be returned to later on in this document.

The calibration parameters of the speed profile 12 comprise the parameters defining the variation as a function of time in the jerk, i.e. in the values of the jerks J1 and J3 applied in the initial sub-phase 121 and final sub-phase 123, respectively. In the rest of the document, the multiplicative factor k is defined such that J3=k.J1.

The calibration parameters of the speed profile 12 also comprise the minimum acceleration value Ac applied in the intermediate sub-phase 122.

The times T′1 to T′3 will be defined based on the calibration parameters described above in respect of the speed profile 12.

A method for calibrating the speed profile 12 will be described below with reference to FIG. 5.

FIG. 5 shows a flowchart of five sub-steps C1 to C5 of implementation of the calibrating method.

The method comprises an iterative loop of sub-steps C1 to C4. The iterative loop makes it possible to determine a value for each of the calibration parameters J1 and Ac that allows the autonomous vehicle 100 to travel the distance DREF separating it from the stop position PA under jerk and acceleration conditions meeting comfort criteria.

Subsequently, sub-step C5 determines the speed profile 12 based on the values determined for the calibration parameters J1, k and Ac.

Upstream of the first computation, an initial value is assigned to the calibration parameters. For example, Ac=−2 m/s², J1=−0.25 m/s³, and k=−3. The respective values of the parameters J1 and Ac change during the iterations of sub-steps C1 to C4.

In a first sub-step C1, the sign sₖ of the multiplicative factor k is determined.

The formula Math 1 allows the sign sₖ to be determined depending on the accelerations A0, A3 and Ac.

$${s}_{k} = sign ( ( {A}_{3} - {A}_{c} ) \cdot ( {A}_{c} - {A}_{0} ) ) \qquad [ Math 1 ]$$

The multiplicative factor k may then be expressed using the formula Math2

$$k = {s}_{k} \cdot {K}_{calib} \qquad [ Math 2 ]$$

where K_{calib} is the absolute value of the multiplicative factor.

Thus, depending on the accelerations A0, Ac and A3, the formula Math1 allows the sign of the jerks J1 and J3 to be defined in such a way as to make the acceleration vary in the three consecutive sub-phases 121, 122 and 123 relating the values A0, Ac and A3.

Moreover, the chosen value of the jerk J1 must make it possible to implement a speed profile 12 that,
on the one hand, takes into account the speed values V0 and V3 and the acceleration values A0, A3 and Ac, and,
on the other hand, varies according to the three sub-phases 121, 122, 123 defined above.

To achieve this, it is necessary for the absolute value of J1 to be less than or equal to the absolute value of a threshold Jim, defined by the formula Math 3:

$$\vert {J}_{lim} \vert = \vert \frac{\frac{1}{k} \cdot ( {A}_{c}^{2} - {A}_{3}^{2} ) - {A}_{c}^{2} + {A}_{0}^{2}}{2 \cdot ( {V}_{0} - {V}_{3} )} \vert \qquad [ Math 3 ]$$

If |J1| is less than or equal to |Jₗᵢₘ|, then the value of J1 is not modified in sub-step C1, otherwise J1 takes the value of Jₗᵢₘ.

In a second sub-step C2, the respective durations ΔT₁ and ΔT₃ of the sub-phases 121 and 123 are expressed as a function of the speeds V0 and V3, of the accelerations A0, A3 and Ac, and of the jerks J1 and J3, according to the formulae Math 4.

$$Δ {T}_{1} = {T}_{1}^{′} = \frac{{A}_{c} - {A}_{0}}{{J}_{1}} \qquad [ Math 4 ]$$

$$Δ {T}_{3} = {T}_{3}^{′} - {T}_{2}^{′} = \frac{{A}_{3} - {A}_{c}}{{J}_{3}}$$

The durations ΔT₁ and ΔT₃ then make it possible to compute, according to the formulae Math 5, the speeds V₁ and V₂, which are the speeds at the time T′₁ and at the time T′₂, respectively.

$${V}_{1} = {V}_{0} + {A}_{0} \cdot {T}_{1}^{′} + \frac{1}{2} {J}_{1} \cdot {T}_{1}^{′2} \qquad [ Math 5 ]$$

$${V}_{2} = {V}_{3} + \frac{\frac{1}{2} {( {A}_{c} - {A}_{3} )}^{2} + {A}_{3} \cdot ( {A}_{c} - {A}_{3} )}{{J}_{3}}$$

Lastly, the duration of the sub-phase 122 is computed using the formula Math 6

$$Δ {T}_{2} = {T}_{2}^{′} - {T}_{1}^{′} = \frac{{V}_{2} - {V}_{1}}{{A}_{c}} \qquad [ Math 6 ]$$

At the end of sub-step C2, all the parameters corresponding to a candidate speed profile 12, established based on the fixed parameters and on an initial value of the calibration parameters Ac, J1 and k, have therefore been determined.

It is thus possible to compute, in the third sub-step C3, the distance traveled from the point M by the autonomous vehicle 100 according to the candidate speed profile 12. A total profile distance XT, which corresponds to the sum of the distances traveled during each of the phases 121, 122 and 123, is then computed according to the formulae Math 7.

$${X}_{T} = {X}_{1} + {X}_{2} + {X}_{3} \qquad [ Math 7 ]$$

$${X}_{1} = {V}_{0} \cdot {T}_{1}^{′} + \frac{1}{2} \cdot {A}_{0} \cdot {T}_{1}^{′2} + \frac{1}{6} \cdot {J}_{1} \cdot {T}_{1}^{′ 3}$$

$${X}_{2} = {V}_{1} \cdot ( {T}_{2}^{′} - {T}_{1}^{′} ) + \frac{1}{2} {A}_{c} \cdot {( {T}_{2}^{′} - {T}_{1}^{′} )}^{2}$$

$${X}_{3} = {V}_{2} \cdot ( {T}_{3}^{′} - {T}_{2}^{′} ) + \frac{1}{2} {A}_{c} \cdot {( {T}_{3}^{′} - {T}_{2}^{′} )}^{2} + \frac{1}{6} \cdot {J}_{3} \cdot {( {T}_{3}^{′} - {T}_{2}^{′} )}^{3}$$

In the third sub-step C4, the calibration parameters are optimized so that the total distance XT corresponds, with a given accuracy, to the curvilinear distance separating the point M from the first stop position PA; in other words, the calibration parameters are modified so that the distance XT is equal to the distance DREF with a given accuracy.

One embodiment of the optimization process is described below.

In a first sub-step C41, a binary search is made for the acceleration value Ac that allows a total profile distance XT to be obtained that is equal, to within an accuracy threshold, to the curvilinear distance DREF separating the point M from the stop position PA.

The acceleration Ac is located in an interval of values limited by driving-comfort criteria, and in particular by the negative minimum value AMIN and the value 0. If a value A_{OP} of this interval allows a total profile distance X_{T} equal to DREF to be obtained, then a preferential speed profile 12 is defined by the parameters A_{OP}, J1 and k.

If no value A_{OP} is found, then a second sub-step C42 is carried out. The acceleration A, is then set to the AMIN value, and an optimal jerk value allowing a total profile distance X_{T} equal to DREF to be obtained is sought.

The jerk J1 is located in an interval of values limited by driving-comfort criteria, and in particular by the negative minimum value JMIN and the value 0. If a value J_{OP} of this interval allows a total profile distance X_{T} equal to DREF to be obtained, then a speed profile 12 referred to as the alternative speed profile is defined by the parameters AMIN, J_{OP} and k.

If no value J_{OP} is found, then a third sub-step C43 is carried out, which consists in producing a speed profile 12 referred to as the degraded speed profile by setting Ac=AMIN and |J1|=JMAX. In this case, the profile distance X_{T} will be greater than DMAX. However, it is the shortest profile achievable while respecting the acceleration and jerk constraints.

Optimization may require a loop back to step C1 (conditional loop illustrated by a rhombus between steps C4 and C5).

At the end of the optimizing sub-step C4, the value of the calibration parameters has been determined.

Next, a sub-step C5 of computing the speed profile 12 defined by the calibration parameters is carried out.

It will be noted that the speed profile 1 thus computed makes it possible to obtain different input and output jerks, and initial and final accelerations that are not zero.

The profile 12 thus computed allows the autonomous vehicle 100 to implement a slowdown that is comfortable for the users, and to stop at the position PA1 determined by the first detecting means 1.

The autonomous vehicle 100 therefore gradually approaches an approximate first position PA1 of the upcoming stop ARR according to the speed profile 12 implementing a slowdown according to the first slowdown logic.

At a time T2, the upcoming stop ARR enters the range limit of the second detecting means 2. The second step E2 is then carried out.

In step E2, an accurate second position PA2 of the upcoming stop ARR is determined, then a second slowdown logic is implemented to slow down the autonomous vehicle 100.

To implement the second slowdown logic, the second detecting means 2 computes a stopping distance DA2(T2) separating the autonomous vehicle 100 from the accurate stop position PA2 at the time T2 of detection of the upcoming stop by the second detecting means 2.

The point M3 shown in graph G3 of FIG. 3 represents the point of transition between the first slowdown logic and the second slowdown logic. In other words, the point M3 lies both at a distance DA1(T2) from the approximate position PA1, and at a distance DA2(T2) from the second stopping point.

In the graphs G3 and G4, the line 600 represents a line of arrival of the vehicle at the upcoming stop ARR located at the position PA2 detected by the second detecting means 2.

The distance difference ADA between the lines 500 and 600 represents the error in the estimation of the position of the upcoming stop ARR induced by the lack of accuracy of the first detecting means 1.

The line 700 represents the start of implementation of the second slowdown logic, the lines 600 and 700 being separated by DA2(T2).

The curve 22 drawn with a thin line represents the speed profile planned for the autonomous vehicle 100 in step E2, while the curve 26 drawn with thick line represents the speed profile implemented by the vehicle as it moves. Thus, the points M3 and M4 shown in graphs G3 and G4 are points of variation in the speed of the autonomous vehicle 100 along the curve 22.

In the described embodiment, the second slowdown logic consists of one or more braking phases 22 determined via the same computing method as the braking phase 12 of the first slowdown logic.

In this embodiment, the speed profile 22 of the braking phase according to the second slowdown logic meets the following criteria:
the speed profile 22 allows the autonomous vehicle to reach the position PA2 with a substantially zero speed, and/or
the speed profiles 12 and 22 exhibit continuity in speed and acceleration at point M3, and/or
the speed profile 22 implements jerks the absolute value of which is less than a first limit threshold JMAX.

In a preferred embodiment-described below with reference to FIG. 6 and corresponding to the most frequent situation where the autonomous vehicle is heading toward the stopping point without needing to accelerate
the speed profile 22 further meets the following criteria:
the speed profile 22 implements negative accelerations greater than a limit threshold AMIN, the threshold AMIN being able to be considered a maximum deceleration in absolute value, and/or
the speed profile 22 is composed of three consecutive sub-phases, an initial sub-phase 221 having a constant negative jerk J′1, an intermediate sub-phase 222 having a jerk J′2 of zero, and a final sub-phase 223 having a constant positive jerk J′3, and/or
the positive jerk J′3 of the final sub-phase 223 is greater than the absolute value of the negative jerk J′1 of the initial sub-phase 221.

Advantageously, in the preferred embodiment, the speed profile 22 meets all of these criteria.

Other embodiments of the speed profile 22, which are not described in this document, are however covered by the scope of the managing method according to the invention.

For example, when the vehicle is driving on a slope such that its negative deceleration is great,
in the initial sub-phase 221 acceleration may increase from a very negative first value A′0 to a negative second value A′c greater than the first value A′0,
then it may be constant in the intermediate sub-phase 222,
then it may increase again to a third value A′3 in the final sub-phase 223. In this case, the jerk J′1 will be positive and of same sign as the jerk 3.

Likewise, in an alternative embodiment of the speed profile 22, a third negative acceleration value A′3 could be implemented at the end of the final sub-phase 223, which acceleration value would be less than the first acceleration value A′0 of the start of the initial sub-phase 221. In this case, the jerk J′3 would be negative and of same sign as the jerk J′1.

The position of the second stop position may change depending on data delivered by the second detecting means 2, and this will require the speed profile 22 to be recomputed to reflect a new position of the autonomous vehicle 100 relative to a new position of the upcoming stop.

The preferred embodiment of a speed profile 22 at a time t is therefore described below generically with reference to FIG. 6, between a given position M of the autonomous vehicle 100 at the time t, the point M possibly corresponding to the point M3, and a stop position PA known at the time t, the stop position possibly corresponding to the second stop position PA2.

The curvilinear distance separating the positions M and PA at the time t is denoted DREF.

Graphs G8, G9 and G10 in FIG. 6 show the variation as a function of time in the jerk, acceleration and speed of the autonomous vehicle according to the speed profile 22, between point M (at the time T=0 s) and the stop position PA.

The speed profile 22 is defined by a set of parameters shown in graphs G8 to G10, including
parameters, referred to as fixed parameters, that are determined by path constraints at the point M and at the stop position PA, and
parameters, referred to as calibration parameters, the value of which may be modified so as to define a path between the point M and the position PA that respects comfort thresholds relating to jerk and acceleration.

The fixed parameters and the calibration parameters described below together make it possible to define the speed profile 22 in the three consecutive sub-phases 221, 222, 223 described above.

In the preferred embodiment, the initial sub-phase 221 takes place between the times T=0 s and T=T″1. During this sub-phase,
the jerk J′1 is strictly negative and constant,
acceleration is a strictly decreasing linear function of time: it varies between two negative values A′0 (at t=0 s) and A′c (at t=T″1),
speed is therefore a strictly decreasing function of the time varying between a value V′0 (at T=0 s) and a value V′1 (at T=T″1).

In the preferred embodiment, the intermediate sub-phase 222 takes place between the time T=T″1 and a time T=T″2. During this sub-phase,
the jerk J′2 is zero,
acceleration therefore remains constant as a function of time: it is equal to the strictly negative value A′c between the times T″1 and T″2,
speed is therefore a strictly decreasing linear function of time varying between the value V′1 (at t=T″1) and a value V′2 (at t=T″2).

In the preferred embodiment, the final sub-phase 222 takes place between the time T=T″2 and a time T=T″3. During this sub-phase,
the jerk J′3 is strictly positive and constant,
acceleration is therefore a strictly increasing linear function of time varying between the negative value A′c (at T=T″2) and a negative value A′3 (at T=T″3),
speed is therefore a strictly decreasing function of time varying between the value V′2 (at t=T″2) and a value V′3 (at t=T″3).

The fixed parameters of the speed profile 22 comprise the speed V′O and acceleration A′0 of the vehicle at the time T=0 s. Since speed and acceleration are continuous at the point M, the speed V′0 is equal to the speed of the autonomous vehicle 100 measured at the point M, and the acceleration A′0 is equal to the acceleration of the autonomous vehicle 100 measured at the point M.

The fixed parameters of the speed profile also comprise the speed V′3 and acceleration A′3 of the vehicle at the position PA. Since the autonomous vehicle 100 must stop at the position PA, the parameters V′3 and A′3 are constants very close to 0. Their respective values may be set during configuration of the vehicle. The values V′3 and A′3 will be returned to later on in this document.

The calibration parameters of the speed profile 22 comprise the parameters defining the variation as a function of time in the jerk, i.e. in the values of the jerks J′1 and J′3 applied in the initial sub-phase 221 and final sub-phase 223, respectively.

The calibration parameters of the speed profile 22 also comprise the minimum acceleration value A′c applied in the intermediate sub-phase 222.

The times T″1 to T″3 will be defined based on the calibration parameters described above in respect of the speed profile 22.

The method applied to calibrate the speed profile 22 is similar to the method described with reference to FIG. 5 for calibrating the speed profile 12 of the first slowdown logic.

At the end of the calibrating step, a speed profile 22 is obtained that allows the autonomous vehicle 100 to implement a slowdown that is comfortable for the users, and to stop at the position PA2 determined by the second detecting means 2.

As illustrated by the graph G4 of FIG. 3, and in particular by the point M4, the autonomous vehicle 100 therefore gradually approaches the accurate position PA2 of the upcoming stop ARR according to the speed profile 22 implementing a slowdown according to the second slowdown logic.

Thus, the autonomous vehicle 100 is first controlled according to at least one speed profile 12, implementing the first slowdown logic, to reach the approximate first stop position PA1 with a substantially zero speed V3.

However, the at least one speed profile 12 is not intended to be followed right up to the position PA1. Specifically, before reaching the first stop position PA1, the autonomous vehicle 100 switches to at least one speed profile 22 implementing the second slowdown logic, the at least one speed profile 22 allowing it to reach the accurate second stop position PA2 with a substantially zero speed V′3.

The decision to assign a non-zero value to V3 and then V′3 is justified by the fact that, in certain embodiments of the invention, the set of sensors 6, and in particular the speed sensor, measuring the current value of the speed of the autonomous vehicle, does not allow very low speeds to be measured, for example speeds less than about 1 km/h (i.e. 0.3 m/s).

One solution is to delegate final management of stoppage to a complementary module that will implement an open-loop slowdown ramp over the last tens of centimeters of the speed profile.

In addition or alternatively, the speed profile 22 implemented in the second slowdown logic could be defined so that the vehicle reaches a position located a very short distance, 50 cm for example, upstream of the stop position PA2 at a very low speed (e.g. 1 km/h) and with a moderate deceleration (e.g. 1 m/s²). The last few centimeters of the path would then be driven according to an open-loop deceleration ramp.

All in all, the invention associates two complementary types of slowdown logic:
a first slowdown logic that allows implementation of braking to be anticipated with a view to stopping the autonomous vehicle 100 at a position determined by a sign, then
a second slowdown logic that allows the accuracy of the implementation of the braking to be increased so as to halt the autonomous vehicle 100 at the position determined by the sign.

The first slowdown logic requires a first detecting means, the range of which is preferably at least one or more hundreds of meters, and the accuracy of which may be relatively low, for example of the order of a few meters. The first detecting means may be a GPS location on a standard map.

The second detection logic requires a second detecting means the accuracy of which is high, for example one having a margin of error of less than a few tens of centimeters, or even less than ten centimeters, or even less than one centimeter, and the range of which may be relatively low, for example of the order of a few tens of meters. The second detecting means may be a front-view camera.

Thus, by combining the first and second slowdown logic, the invention allows the autonomous vehicle 100 to be halted at a position determined by a sign, on the one hand while offering high comfort and braking accuracy and on the other hand while using detecting means that are commonly installed on autonomous vehicles.

1-10. (canceled)

11. A method for managing longitudinal speed of an autonomous vehicle, the autonomous vehicle traveling on a roadway comprising a stop sign located in front of the autonomous vehicle, the autonomous vehicle being equipped with a first detecting means of a first range and with a second detecting means of a second range, the first range being greater than the second range, the method comprising:
first detecting the stop sign with the first detecting means and implementing first slowdown logic to slow down the autonomous vehicle, and
second detecting the stop sign with the second detecting means and implementing second slowdown logic to slow down the autonomous vehicle,
wherein the first and second slowdown logic implement jerks with an absolute value of less than a first limit threshold, and
wherein the second slowdown logic controls stoppage of the autonomous vehicle with an accuracy of one centimeter relative to the stop sign, or of ten centimeters relative to the stop sign, or of several tens of centimeters relative to the stop sign.

12. The method as claimed in claim 11, wherein the first and second slowdown logic implement negative accelerations greater than a second limit threshold.

13. The managing method as claimed in claim 11, wherein the first detecting comprises determining, at a first time, an approximate first position of the stop sign, and the second detecting comprises determining, at a second time, an accurate second position of the stop sign, the second time being strictly after the first time.

14. The managing method as claimed in claim 13, wherein the first slowdown logic initiates a first decelerating phase when the vehicle reaches a given distance from the approximate first position of the stop sign.

15. The managing method as claimed in claim 14, wherein the second slowdown logic starts a second decelerating phase at the second time, and the second decelerating phase exhibits continuity in speed and acceleration with the first decelerating phase.

16. The managing method as claimed in claim 15, wherein at least one of
the absolute value of the jerk at the end of the first decelerating phase is greater than the absolute value of the jerk at the start of the first decelerating phase, and
the absolute value of the jerk at the end of the second decelerating phase is greater than the absolute value of the jerk at the start of the second decelerating phase.

17. The managing method as claimed claim 15, wherein at least one of
the first decelerating phase is composed of three first consecutive sub-phases, the three first consecutive sub-phases including a first initial sub-phase having a first non-zero constant jerk, a first intermediate sub-phase having a jerk of zero, and a first final sub-phase having a second non-zero constant jerk, and
the second decelerating phase is composed of three second consecutive sub-phases, the three second consecutive sub-phases a second initial sub-phase having a third non-zero constant jerk, a second intermediate sub-phase having a jerk of zero, and a second final sub-phase having a fourth non-zero constant jerk.

18. The managing method as claimed in claim 17, wherein at least one of
the second jerk is the product of the first jerk multiplied by a first multiplicative factor, and
the fourth jerk is the product of the third jerk multiplied by a second multiplicative factor.

19. The managing method as claimed in claim 17, wherein at least one of
the second jerk is the product of the first jerk multiplied by a first multiplicative factor having a sign that is the sign of the product between the difference between a first acceleration of the end of the first final sub-phase and a second acceleration of the first intermediate sub-phase, and the difference between the second acceleration and a third acceleration of the start of the first initial sub-phase, and
the fourth jerk is the product of the third jerk multiplied by a second multiplicative factor having a sign that is the sign of the product between the difference between a fourth acceleration of the end of the second final sub-phase and a fifth acceleration of the second intermediate sub-phase, and the difference between the fifth acceleration and a sixth acceleration of the start of the second initial sub-phase.

20. A device to manage a longitudinal speed of an autonomous vehicle equipped with a brake actuator, the device comprising:
hardware and/or software elements configured to implement the managing method as claimed in claim 11.

21. An autonomous vehicle: comprising:
the device as claimed in claim 20.
